(19) United States
(12) Patent Application Publication
(10) Pub. No.: US 2026/0326699 A1
(43) Pub. Date: Oct. 22, 2026

(54) Method for Operating an Occupant Restraint Device of a Vehicle

(71) Applicant: Mercedes-Benz Group AG, Stuttgart (DE)

(72) Inventors: Michael FEHRING, Neuhausen (DE); Ulrich SCHICK, Nagold (DE)

(21) Appl. No.: 19/122,485

(22) PCT Filed: Oct. 19, 2023
(86) PCT No.: PCT/EP2023/079199

§ 371 Date: Apr. 18, 2025

(30) Foreign Application Priority Data
Oct. 24, 2022 (DE) 10 2022 003 927.3

(51) Int. Cl. B60R 21/0134; B60N 2/02; B60N 2/427; B60R 21/01; B60R 21/0136; B60R 21/015; B60R 21/231

(52) U.S. Cl. CPC B60R 21/0134; B60N 2/0276; B60N 2/42736; B60N 2/42745; B60R 21/0136; B60R 21/01544; B60R 21/231; B60R 2021/01272; B60R 2021/23169

(57) ABSTRACT

A method for operating an occupant restraint device in an automatically driving vehicle includes activating an automatic driving mode of the automatically driving vehicle when a seatbelt status of an occupant of a vehicle seat is detected and activating restraining elements of the occupant restraint system in a coordinated manner depending on a position of the vehicle seat and depending on a situational collision status from a point in time of a detected imminent collision of the automatically driving vehicle. When a reclined position of the vehicle seat is detected and a collision of the automatically driving vehicle is detected as imminent, a retractor of a seatbelt of the occupant restraint device is controlled and the seatbelt in a shoulder belt region is tightened by an electric motor. After the collision has occurred, a seat-integrated retractor is triggered pyrotechnically and a lap belt tensioner is activated.

### BACKGROUND AND SUMMARY OF THE INVENTION

The invention relates to a method for operating an occupant restraint device for protecting an occupant on a vehicle seat in an automatically driving vehicle, wherein the occupant restraint device has at least one airbag and a seatbelt with at least one belt tensioner as restraining elements and a distinction is made by means of a control unit of the occupant restraint device at least between an upright position and a reclined position of a seat backrest of the vehicle seat.

A vehicle occupant restraint device and a method for operating a vehicle occupant restraint device are known from DE 10 2017 116 905A1. The vehicle occupant restraint device for protecting a vehicle occupant on a vehicle seat comprises several restraint elements and a control device. Here, a first restraining element comprises an air bag module with an air bag, and a second restraining element comprises a seatbelt with a belt retractor, wherein the seatbelt is operatively connected to a tensioning device. The control device has at least one sensor element for determining the position of the vehicle seat, such that in a restraint situation the control device distinguishes between a first situation, in which the vehicle seat with the vehicle occupant is in a position in the region of a standard position in relation to the air bag of the first restraint element, and a second situation, in which the vehicle seat with the vehicle occupant is in a position outside the standard position. In the first situation, the control device only activates the first and second restraint elements, whereas in the second situation, the control device can activate and/or switch on a third restraint element that is integrated into the vehicle seat and/or is operatively connected to the vehicle seat, such that the vehicle seat is firstly moved via the third restraint element into a position in the region of the standard position.

The object of the invention is to specify a novel method for operating an occupant restraint device of a vehicle.

A method for operating an occupant restraint device for protecting an occupant on a vehicle seat, in particular an integral belt seat, in an automatically driving vehicle, wherein the occupant restraint device has at least one airbag and a seatbelt with at least one belt tensioner as restraining elements, a distinction is additionally made by means of a control unit of the occupant restraint device at least between an upright position and a reclined position of a seat backrest of the vehicle seat. According to the invention, it is provided that, to activate an automatic driving mode of the vehicle, a seatbelt status of at least occupants of a front row of seats of the vehicle in the longitudinal direction of the vehicle is detected. With a belt buckle tongue detected as the belt status and plugged into a belt buckle allocated to the vehicle seat, the automated driving operation of the vehicle is activated, and the restraining elements of the occupant restraint device are controlled and activated or triggered in a coordinated manner depending on a set position of the vehicle seat and depending a situational collision status from a point in time of a detected imminent collision, in particular a frontal collision, with the vehicle.

An application of the method is based on conventional, tried and tested restraint elements that are usually installed in the vehicle, which can significantly reduce the risk of injury to an occupant on the vehicle seat in the set reclined position in the event of a vehicle collision.

Here, the method can fulfil all legal and so-called rating requirements relatively reliably to the greatest possible extent.

The vehicle seat having the reclined position does not require any additional adaptation to the occupant restraint device in order to use the method, such that it can be used both for the upright position of the seat backrest and for the reclined position of the seat backrest and the occupant.

A seat structure of the vehicle seat and its connection to a floor assembly of the vehicle must in principle fulfil the strength requirements for the integral belt seat, such that no additional effort is required to carry out the method.

Both simulative and prototypical investigations to determine potential are comparatively easy to carry out.

In a design of the method, when the reclined position of the vehicle seat is detected and a collision imminent for the vehicle is detected, a belt tensioner of the seatbelt is controlled, and the seatbelt in the shoulder belt region is tightened by an electric motor and, after the collision has occurred, a lap belt tensioner and a seat-integrated retractor are also controlled and pyrotechnically activated. By tightening the seatbelt by controlling all existing belt tensioners allocated to the seatbelt, the occupant is optimally secured to the vehicle seat, such that the load on the occupant at the time of the collision and any collision-related deceleration of the vehicle can be reduced. The occupant participates in collision-related accelerations of the vehicle.

A further design provides that, when the pyrotechnic belt tensioning system is activated, an upright positioning of the seat backrest of the vehicle seat is released pyrotechnically by cancelling a locking mechanism of the seat backrest. The aim here, driven by an impact energy at the time of collision, is a force-controlled uprighting of the occupant. The impact usually causes the seat backrest to straighten without the application of any further force, wherein the method provides for the controlled uprighting of the seat backrest. Due to the uprighting of the seat backrest, comparatively serious injuries to the lumbar spine of the occupant can be extensively avoided.

If the vehicle seat, in particular the seat backrest, is in the reclined position, then relatively high forces act in the event of a collision, which act on a spine of the occupant and are absorbed by the seat surface, in particular through compression due to the support of the pelvis of the occupant in the seat surface. This compression of the spine can be largely eliminated by the uprighting of the seat backrest.

In a development, the upright positioning of the seat backrest is braked before the seat backrest reaches an upright end position, such that a load acting on the occupant due to the upright positioning and an undamped abrupt braking of the seat backrest and an associated risk of injury, in particular to a cervical spine of the occupant, can be reduced.

A further possible design of the method provides that the electromotive belt tensioning of the shoulder belt region and a lap belt region of the seatbelt is maintained at a predetermined force level during the upright positioning of the seat backrest until it reaches its upright end position. The occupant is thus still attached to the vehicle seat, wherein the lap belt region is tightened with a maximum force level in order to substantially prevent the occupant from slipping through under the lap belt region of the seatbelt. This slipping through or submersion is also referred to as the submarining effect.

In a design, once the seat backrest has reached the upright end position, the vehicle seat lock is released pyrotechnically to carry out a controlled longitudinal movement in the direction of travel of the vehicle. After the seat backrest has been raised, the occupant is in an upper body position optimized for the collision, in which the vehicle seat lock is released. The occupant initially decelerates with a certain force level below a belt force limiter and is braked uniformly within the vehicle. The deceleration thus does not have an extreme value, but a constant force level.

The occupant can have less deceleration due to released forward movement, i.e., the longitudinal movement of the vehicle seat in the direction of travel, wherein acceleration peaks acting on the vehicle can be filtered, i.e., the acceleration peaks do not affect the occupant.

A starting point for an internal deceleration caused by the longitudinal movement of the vehicle seat can be chosen in such a way that an initial moderate vehicle deceleration initially takes place without the internal deceleration and the longitudinal movement of the vehicle seat is released by the pyrotechnical release of the locking mechanism as soon as a deceleration maximum acts on the vehicle. This deceleration maximum is reached when the vehicle is no longer moving in the collision situation.

In a possible development, the vehicle seat is braked in a damped manner in the region of its longitudinal end position arranged in the direction of travel. In other words, the vehicle seat is braked in a damped manner at the end of an internal deceleration path. The longitudinal movement of the vehicle seat is thus not stopped abruptly, such that a load resulting from an abrupt stop of the longitudinal movement of the vehicle seat does not act on the occupant, whereby an additional risk of injury to the occupant can be extensively excluded.

Moreover, a design provides that a force level of the electromotive tightening of the seatbelt in the shoulder belt region is reduced by a predetermined amount when the region of the longitudinal end position of the vehicle seat is reached. By setting a shoulder belt force, i.e., the force level of the tightening of a belt force limiter, to a lower force level, the occupant, in particular their upper body, is enabled to shift forwards in order to dissipate residual body energy, in particular acceleration energy. This results in a finalization of movement in the vehicle seat. Here, it is possible to specify a force level to which a tightening force of the seatbelt in the shoulder belt region is reduced depending on the weight of the occupant on the vehicle seat.

In a further design, a driver airbag and/or a front passenger airbag is or are triggered in a first stage depending on a detected seat occupancy. In particular, the driver airbag and/or the front passenger airbag is or are triggered in the first stage in order to ensure additional impact protection for the occupant on the vehicle seat against comparatively hard contours of a vehicle interior. Here, a lower degree of inflation of the driver airbag and/or the front passenger airbag and a resulting lower hardness of the respective airbag triggered in the first stage can adaptively reduce the relatively low residual energy of the respective occupant in a more targeted manner. The respective airbag is thus less inflated, resulting in a lower risk of injury for the occupant hitting the airbag.

If the occupant is a driver of the vehicle in a manual driving mode who is sitting in the driver's seat, the driver airbag is triggered when the steering wheel is retracted, for example.

In a further design, a respective knee airbag is triggered in a first stage in addition to triggering the driver airbag and/or the front passenger airbag in order to ensure additional impact protection for the occupant on the vehicle seat against comparatively hard contours of the vehicle interior. This further reduces the risk of injury to the occupant.

Exemplary embodiments of the invention are explained in more detail below by means of the drawings.

### BRIEF DESCRIPTION OF THE DRAWINGS

FIG. 1, schematically, shows a cut-out of a vehicle with an occupant on a vehicle seat in an upright position;

FIG. 2, schematically, shows a cut-out of the vehicle with the occupant on a vehicle seat in a reclined position;

FIG. 3, schematically, shows a cut-out of the vehicle with the occupant in the reclined position in the event of a detected imminent collision with the vehicle;

FIG. 4, schematically, shows a cut-out of the vehicle with the occupant on the vehicle seat in the reclined position after the collision occurs;

FIG. 5, schematically, shows a cut-out of the vehicle with upright positioning of a backrest of the vehicle seat of the occupant;

FIG. 6, schematically, shows a cut-out of the vehicle after uprighting the backrest of the vehicle seat of the occupant;

FIG. 7, schematically, shows a cut-out of the vehicle when carrying out a longitudinal movement of the vehicle seat in the direction of travel; and

FIG. 8, schematically, shows a cut-out of the vehicle with the occupant on the vehicle seat and triggered driver airbag and knee airbag.

### DETAILED DESCRIPTION OF THE DRAWINGS

Parts corresponding to one another are provided with the same reference number in all Figures.

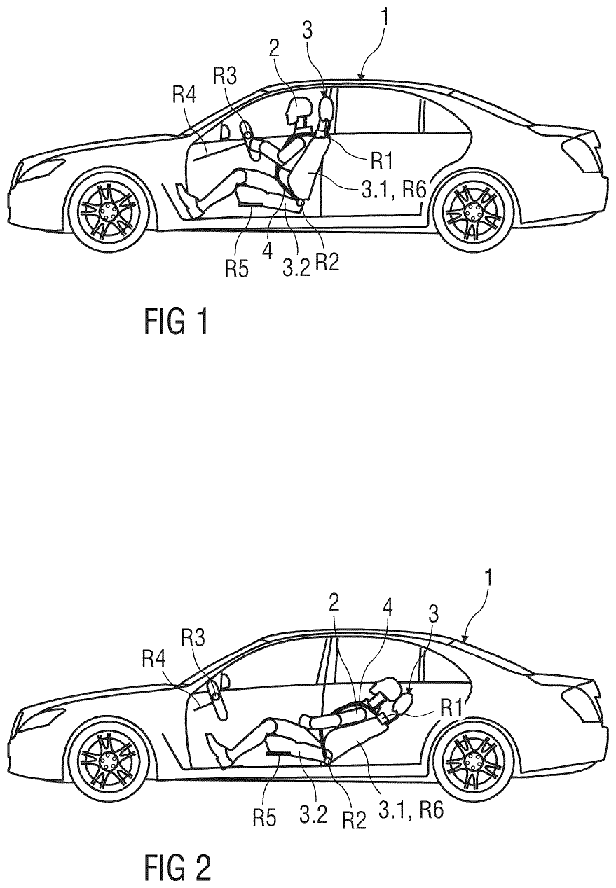

FIG. 1 shows a cut-out of a vehicle 1 with an occupant 2 on a vehicle seat 3 with the seat backrest 3.1 raised, such that the occupant 2 has an upright sitting position on the vehicle seat 3. For example, this seating position of the occupant 2 can be referred to as the driving position.

FIG. 2 shows a cut-out of the vehicle 1 with the occupant 2 on the vehicle seat 3 in a reclined position.

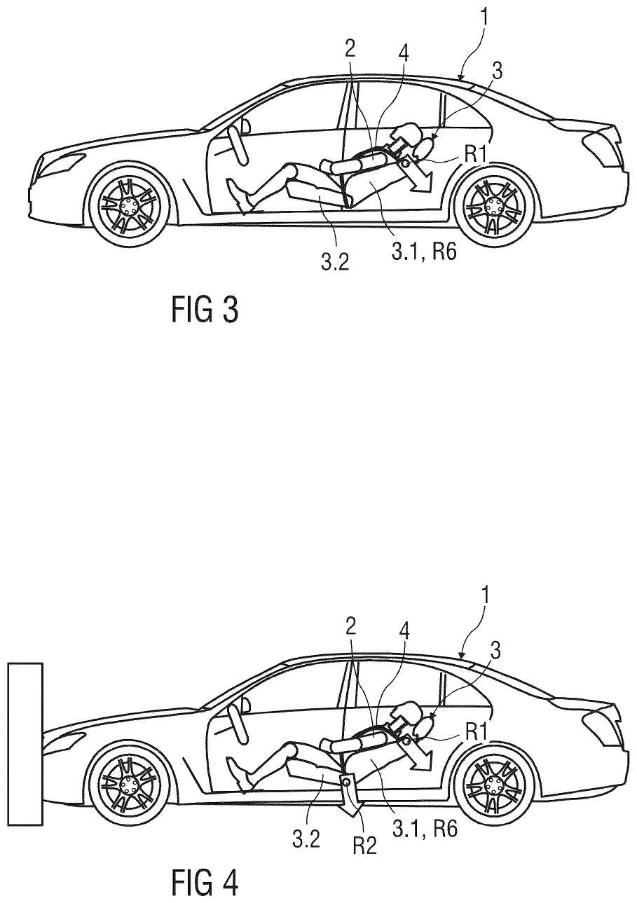

FIGS. 3 to 8 each show a cut-out of the vehicle 1 with the occupant 2 on their vehicle seat 3 before and during a collision, in particular a head-on collision.

By means of a generally known occupant restraint device comprising previous vehicle-fixed restraint elements R1 to Rn, a comparatively high level of injury protection for the occupant 2 on the vehicle seat 3 can be realized, provided that the vehicle seat 3 has an upright position and the occupant 2 on the vehicle seat 3 has an upright sitting position.

With regard to variable seating positions, in particular a reclined position of the occupant 2 on the vehicle seat 3, the seat backrest 3.1 thereof is correspondingly inclined, a functionality and thus a protective effect of the restraining elements R1 to Rn of the occupant restraint system shown in more detail in the following figures is restricted.

In particular in the reclined position, a so-called relaxed position, the restraint elements R1 to Rn cannot fulfil their protective function for the occupant 2 or can only do so inadequately, such that there is a comparatively high risk of injury to the occupant 2 despite the restraint elements R1 to Rn being activated or triggered.

The vehicle 1 has an assistance system for automatic, in particular autonomous driving operation, in which a driving task is performed entirely by the vehicle 1, in particular the assistance system. A driver as occupant 2 of the vehicle 1 thus has the option of pursuing another activity, for example relaxing in the reclined position of the vehicle seat 3.

Below, a method for operating an occupant restraint system of the vehicle 1 is described, which optimizes injury protection for the occupant 2 in the reclined position of the vehicle seat 3 and thus a protective function for the reclined occupant 2 can be ensured as far as possible. In particular, the method enables comparatively safe kinematic restraint for a driver and a front passenger as occupants 2 from the reclined position in the event of a collision of the vehicle 1, in particular a head-on collision.

The vehicle seat 3 is an integral belt seat in which the seatbelt 4 with its components is arranged on the vehicle seat 3 or integrated into it. A connection of the vehicle seat 3 to a main floor of the vehicle 1 is designed with regard to its strength for load case requirements in relation to the vehicle seat 3.

As restraint elements R1 to Rn, the occupant restraint system of vehicle 1 has the seatbelt 4 with an electromotive retractor R1, a pyrotechnic retractor not shown in more detail, an electromotive lap tightener R2, a two-stage deployable driver airbag R3, a two-stage deployable front passenger airbag not shown in more detail, a telescopic and/or deformable steering column R4, a seat slide R5 with a pyrotechnically deployable movement mechanism, the seat backrest 3.1 as a so-called kinematic backrest R6 with a pyrotechnically deployable kinematic mechanism and a knee airbag R7.

In order to activate the automatic driving mode, in particular the autonomous driving mode of the vehicle 1, it is necessary for the occupants 2 of a first row of seats, i.e., the driver and possibly a front passenger, to have fastened their seatbelt 4, wherein a belt buckle tongue, not depicted, is inserted into a corresponding belt buckle. A belt status as to whether the respective occupant 2 of the first row of seats has fastened their seatbelt 4 is detected, for example, by means of a belt buckle switch. If such a belt status is detected, the automatic driving mode of the vehicle 1 can be activated.

Furthermore, the method for operating the occupant restraint device provides that there are no other occupants in the rear region.

FIG. 3 shows a cut-out of the vehicle 1 with the occupant 2 in the reclined position during a detected imminent collision with the vehicle 1, in particular a head-on collision.

Here, it is provided that, before a collision occurs, the donned seatbelt 4 is tightened electromotively by means of the activated retractor R1, whereby the occupant 2 is fixed to the vehicle seat 3, in particular to the seat backrest 3.1.

In particular, the activation of the retractor R1 is carried out depending on detected signals of an environment sensor system of the vehicle 1, for example by means of detected signals from at least one radar-based sensor.

Once the collision of the vehicle 1 has occurred, the seat-integrated retractor R1 is triggered pyrotechnically and the electromotive lap tightener R2 is activated. Thus, the seatbelt 4 is tightened at all three end points, as shown in FIG. 4.

At the same time as the electromotive and pyrotechnical belt tensioning, a movement of the seat backrest 3.1, i.e., the kinematic backrest R6, is released pyrotechnically. In particular, the release takes place by means of an airbag unit, for example an airbag control unit. For this purpose, a locking mechanism, which comprises two locking bolts, for example, is released pyrotechnically such that the occupant 2 is raised by means of the kinematic backrest R6, i.e., has an upright sitting position.

The aim is thus to force the occupant 2 upright, driven by collision-related impact energy.

As a result of the collision, i.e., the impact, the seat backrest 3.1 straightens up without any further application of force. An upright positioning is here controlled, wherein the upright positioning of the seat backrest 3.1 is braked before the seat backrest 3.1 reaches an upright end position. In particular, damped braking of the seat backrest 3.1 is carried out by means of at least one unspecified end position damper. Such end position damping when the seat backrest 3.1 reaches the upright end position reduces a peak load acting on the occupant 2.

Consumable elements for force control of the upright positioning of the seat backrest 3.1 can be realized directly on the recliner, i.e., on the vehicle seat 3, using known technologies, for example by cutting, wire drawing, etc. The end position damping can also be realized in this way.

Raising the seat backrest 3.1 can significantly reduce the risk of injury to the occupant 2, in particular their lumbar spine, since compression of the spine in the upright end position of the seat backrest 3.1 can be extensively avoided.

A belt force acting on the occupant 2 by means of the seatbelt 4 is greater than a force for the upright positioning the seat backrest 3.1, wherein the belt force can be very high due to a switchability in relation to a force level.

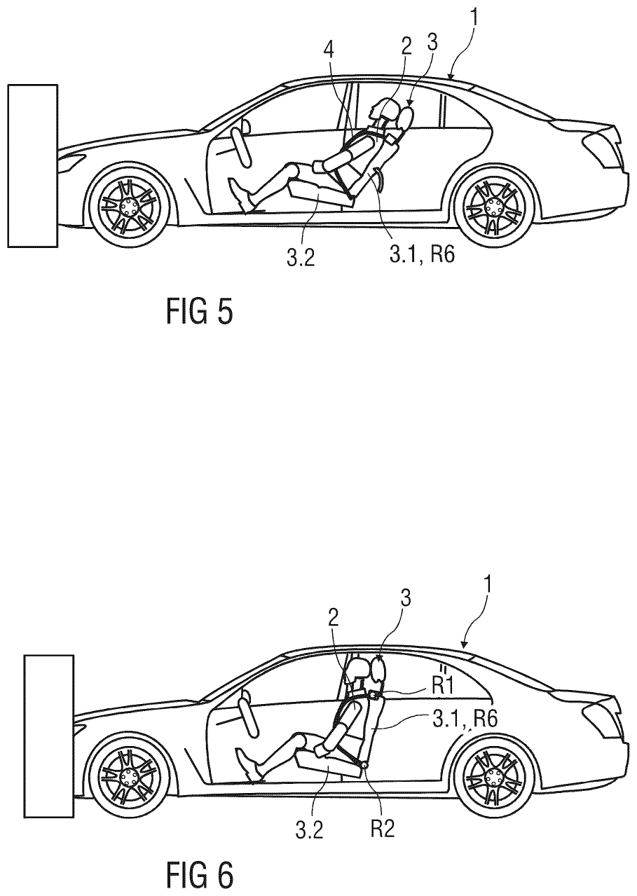

During the upright positioning of the seat backrest 3.1 shown in FIG. 5, the occupant 2 is fixed to a seat cushion 3.2 of the vehicle seat 3 forming a seat surface with the maximum force level of the pelvic tensioner R2 to prevent it from slipping through under a pelvic belt region of the seatbelt 4, as shown in FIG. 6. A tightening force acting on a shoulder belt region of the seatbelt 4 also remains comparatively high until the seat backrest 3.1 reaches its upright end position.

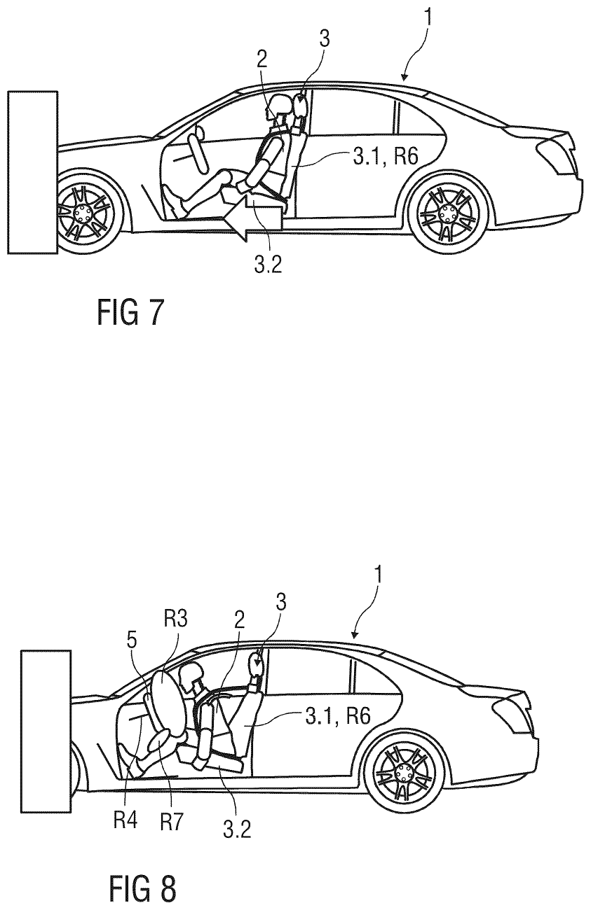

After the seat backrest 3.1 has reached its upright end position and the occupant 2 thus has an optimized upper body position in relation to the collision, a controlled longitudinal movement of the vehicle seat 3 in the direction of travel of the vehicle 1 is released pyrotechnically, as shown in FIG. 7. For this purpose, for example, a locking mechanism of the vehicle seat 3, in particular a locking mechanism of the seat slide R5 by means of bolts in relation to seat rails, is released pyrotechnically. The longitudinal movement of the vehicle seat 3 with the occupant 2 is referred to as internal deceleration, since this takes place inside the vehicle 1.

Here, the occupant 2 decelerates with the vehicle seat 3 initially only with a certain force level below a force level of a belt force limiter and is braked uniformly within the vehicle 1. Here, the occupant 2 has a lower deceleration due to a forward movement, whereby load peaks acting on the occupant 2 can be largely avoided.

A start time of the internal deceleration can be chosen, wherein an initial moderate vehicle deceleration initially takes place without internal deceleration. The internal deceleration, i.e., the release of the vehicle seat 3 to perform the longitudinal movement, takes place when the vehicle 1 has reached its maximum deceleration. The maximum deceleration of vehicle 1 is reached when vehicle 1 no longer moves in the collision, i.e., accident. An approximate rectangular characteristic curve can be modulated due to a uniform deceleration.

At the end of an inner deceleration path of the vehicle seat 3 with the occupant 2, i.e., in the region of a longitudinal end position of the vehicle seat 3, it is decelerated in a damped manner. A tightening force acting on the shoulder belt region of the seatbelt 4 is reduced to a predetermined force level such that the upper body of the occupant 2 can be shifted forwards on the vehicle seat 3 and thus any residual energy caused by the collision, in particular kinetic energy, can be dissipated, as shown in FIG. 8.

For example, the force level can be set depending on the weight of the occupant 2, such that a certain pre-displacement path can be made available to the occupant 2 to finalize a movement of the occupant 2.

According to the exemplary embodiment shown in FIG. 8, the driver airbag R3 and the knee airbag R7 are additionally triggered in a first stage. By means of the driver airbag R3 triggered in the first stage, impact and/or collision with comparatively hard contours of a vehicle interior is largely prevented when the steering column R4 is retracted and a steering wheel 5 of the vehicle 1 is in a retracted position. Additional impact and/or collision protection is thus ensured, wherein a relatively soft catching of the head and chest of the occupant 2 can be ensured.

If a seat occupancy detection system ascertains that a front passenger seat of vehicle 1 is alternatively or additionally occupied, then a front passenger airbag is triggered in a first stage.

The knee airbag R7 triggered in the first stage also ensures additional impact protection for the occupant 2 on the vehicle seat 3 against comparatively hard contours of the vehicle interior, wherein the knee airbag R7 supports the kinematics of the occupant 2. This can further reduce the risk of injury for occupant 2 again.

In the first stage of deployment of the driver airbag R3 and the knee airbag R7, these have a lower degree of inflation and are thus less hard when the occupant 2 hits the ground.

### LIST OF REFERENCE CHARACTERS

1 Vehicle
2 Occupant
3 Vehicle seat
3.1 Seat backrest
3.2 Seat cushion
4 Seatbelt
5 Steering wheel
R1 Restraining element/retractor
R2 Restraining element/lap tightener
R3 Restraining element/driver airbag
R4 Restraining element/steering column
R5 Restraining element/seat slide
R6 Restraining element/kinematic backrest
R7 Restraining element/knee airbag

1.-9. (canceled)

10. A method for operating an occupant restraint device in an automatically driving vehicle (1), comprising the steps of:
activating an automatic driving mode of the automatically driving vehicle (1) when a seatbelt status of an occupant (2) of a vehicle seat (3) of the automatically driving vehicle (1) is detected; and
activating restraining elements of the occupant restraint system in a coordinated manner depending on a set position of the vehicle seat (3) and depending on a situational collision status from a point in time of a detected imminent collision of the automatically driving vehicle (1);
wherein when a reclined position of the vehicle seat (3) is detected by a control unit of the occupant restraint device and a collision of the automatically driving vehicle (1) is detected as imminent, controlling a retractor (R1) of a seatbelt (4) of the occupant restraint device and tightening the seatbelt (4) in a shoulder belt region by an electric motor;
wherein after the collision has occurred, triggering pyrotechnically a seat-integrated retractor and activating a lap belt tensioner (R2).

11. The method according to claim 10, wherein with the triggering pyrotechnically step, further comprising the step of upright positioning a seat backrest (3.1) of the vehicle seat (3) to an upright end position by cancelling a locking mechanism of the seat backrest (3.1).

12. The method according to claim 11, further comprising the step of damped braking of the seat backrest (3.1) before the seat backrest (3.1) reaches the upright end position.

13. The method according to claim 12, wherein, during the upright positioning of the seat backrest (3.1), the tightening of the seatbelt (4) in the shoulder belt region by the electric motor and a tightening of the lap belt tensioner (R2) is maintained at a predetermined force level.

14. The method according to claim 12, wherein, after the seat backrest (3.1) reaches the upright end position, releasing a locking mechanism of the vehicle seat (3) pyrotechnically and longitudinally moving the vehicle seat (3) in a direction of travel of the automatically driving vehicle (1).

15. The method according to claim 14, further comprising the step of damped braking of the longitudinally moving of the vehicle seat (3) in a region of a longitudinal end position of the vehicle seat (3).

16. The method according to claim 15, wherein, when the vehicle seat (3) reaches the region of the longitudinal end position of the vehicle seat (3), a force level of the tightening of the seatbelt (4) in the shoulder belt region by the electric motor is reduced by a predetermined amount.

17. The method according to claim 10, further comprising the step of triggering a driver airbag (R3) and/or a front passenger airbag depending on a respective detected seat occupancy.

18. The method according to claim 17, further comprising the step of deploying a knee airbag (R7).
